(19) United States
(12) Patent Application Publication
(10) Pub. No.: US 2023/0265998 A1
(43) Pub. Date: Aug. 24, 2023

(54) LIGHT SYSTEMS FOR OVENS

(71) Applicant: WHIRLPOOL CORPORATION, Benton Harbor, MI (US)

(72) Inventor: Rafael PRADO, Joinville (BR)

(21) Appl. No.: 17/678,809

(22) Filed: Feb. 23, 2022

(51) Int. Cl. F21V 33/00; F21V 8/00; F21V 19/00

(52) U.S. Cl. CPC F21V 33/0044; F21V 19/0015; G02B 6/0008; F21Y 2115/10

(57) ABSTRACT

An oven having an illumination device for illuminating an oven cavity, the illumination device may include a light source having a printed circuit board (PCB) arranged exterior to the oven cavity, a light guide extending from the PCB to direct light into the oven cavity via an inlet defined in the frame, and a metal cylinder surrounding the light guide at the inlet to protect the module against microwave leakage.

### TECHNICAL FIELD

Aspects of the disclosure relate to high efficiency oven cavity lighting systems for ovens.

### BACKGROUND

Household appliances often include light sources in order to illuminate the interior cavity of the appliance during operation. For example, cooking appliances such as ovens and microwave ovens often include light sources to allow a user to see into the cavity during cooking. However, the light source should be designed so as to minimize temperature loads imparted on the light source during cooking. Furthermore, the light source should not generate heat, affecting cooking or operation of the oven. Light emitting diodes are often used for their low heat generating factors.

### SUMMARY

An oven having an illumination device for illuminating an oven cavity, the illumination device may include a light source having a printed circuit board (PCB) arranged exterior to the oven cavity, a light guide extending from the PCB to direct light into the oven cavity via an inlet defined in the frame, and a metal cylinder surrounding the light guide at the inlet to protect the module against microwave leakage.

A light device for illuminating an oven cavity, the light device may include a light emitting diode (LED) in communication with a printed circuit board (PCB) arranged exterior to a frame defining the oven cavity, a light guide extending from the LED to direct light into the oven cavity via an inlet defined in the frame, and a cylinder surrounding the light guide at the inlet to protect the module against microwave leakage.

A blocking cylinder for covering an inlet for a light device illuminating an oven cavity configured to block exposure to leaking microwaves, the blocking cylinder may include a first portion configured to receive a distal end of a light guide, the first portion having a cylindrical shape and a first diameter, and a second portion extending from the first portion and configured to receive a gasket for further receiving the light guide, the second portion having a cylindrical shape and a second diameter.

### BRIEF DESCRIPTION OF THE DRAWINGS

The embodiments of the present disclosure are pointed out with particularity in the appended claims. However, other features of the various embodiments will become more apparent and will be best understood by referring to the following detailed description in conjunction with the accompanying drawings in which:

FIG. 1 illustrates a front perspective partial view of a microwave oven, in accordance with one or more embodiments of the disclosure;

FIG. 2 illustrates a perspective view of a light source for the microwave oven of FIG. 1;

FIG. 3 illustrates a cutaway view of the light source of FIG. 2;

FIG. 4 illustrates a cylinder of the light source; and

FIG. 5 illustrates a gasket of the light source.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

Disclosed herein is a light source for a microwave oven. The light source may provide illumination to the oven cavity through a channel defined between the microwave frame and cavity wrapper. The light source may include light emitting diodes (LEDs), printed circuit boards (PCB), etc. The light source may further include a cylindrical light guide configured to guide the light from the PCB to an inlet to provide the light generated from the LEDs into the cavity.

In order to prevent leaking microwaves from leaving the oven cavity and possibly damaging the PCB or other components, the light source may include a blocking cylinder. The blocking cylinder may form a cap or seal over the inlet in order to reflect the waves back into the cavity. The blocking cylinder may be made of metal or other blocking materials. The cylinder may have two portions, the first portion being cylindrical and being configured to receive the light guide. The second portion may also be cylindrical and extend from the first portion, but have a larger diameter than the first portion. This may be in part in order to receive a silicone gasket. The second portion may encapsulate the gasket around the inlet so that the gasket can receive the end of the light guide and seal off the cavity. Accordingly, a low cost, low-modification light source may be presented to minimize or prevent microwave leakage and prolong the life of the light source.

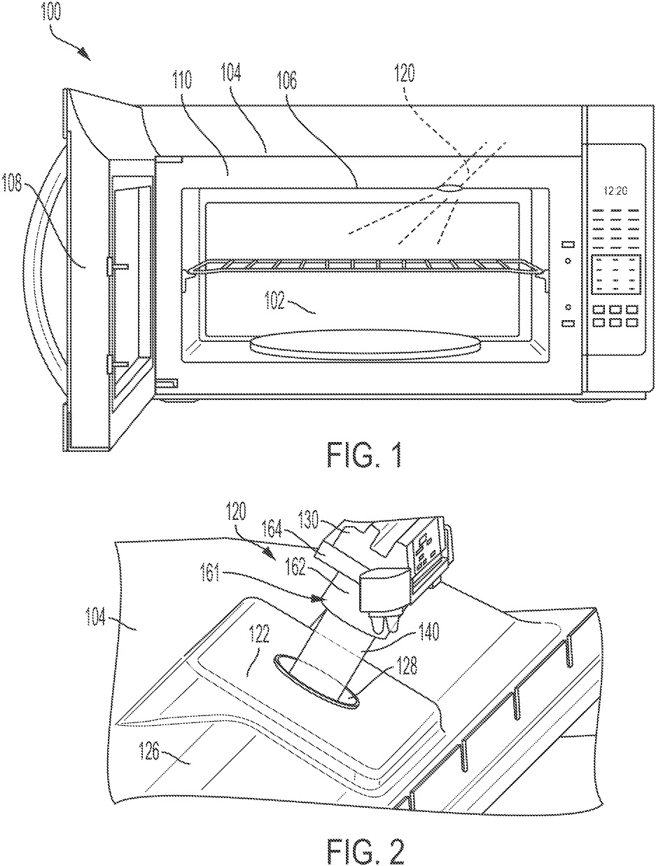

FIG. 1 illustrates a front cutaway view of an oven 100, in accordance with one or more embodiments of the disclosure. In general, the oven 100 may cook food placed into an oven cavity 102 by exposing the food to electromagnetic radiation in the microwave frequency range. This radiation is produced by a magnetron (not shown), where electrons are emitted from a hot cathode to resonant cavities of the anode at speeds that generate the microwave energy. While the examples herein refer to a microwave, similar concepts may also be enjoyed by other oven types.

The oven 100 includes a cavity wrapper 106 that defines an access opening and walls at the top, left side, right side, back and bottom. An oven frame 104 may be arranged around the cavity wrapper 106 and define a channel 110 between the cavity wrapper 106 and the frame 104. A door 108 may be arranged at a front of the oven cavity 102 to selectively cover the access opening. The door 108 may operate to move between an open position where the oven cavity 102 is accessible via the access opening and a closed position where the door 108 seals the opening. The cavity wrapper 106 may be made of a material such as stainless steel or ceramic enamel, to prevent the passage of the radiation outside of the oven cavity 102. The door 108 may include a clear window for observing the food, shielded by a metal mesh to prevent the passage of the radiation.

To perform a cooking cycle, the food is placed in the oven cavity 102, the door 108 is closed, and the magnetron is activated. During operation, microwave energy travels from the magnetron through a waveguide and is distributed into the oven cavity 102 via a mode stirrer. The microwave energy transfers to the food via dielectric heating. Once the food is heated, the magnetron is deactivated, the door 108 is reopened, and the food is removed. The oven 100 may also include a door switch (not shown) that detects whether the door 108 is open or closed, such that the magnetron is automatically deactivated should the door 108 be opened during a cooking cycle.

The magnetron may be driven by electrical components that provide a high voltage source, such as a transformer and capacitor as shown (in other examples a switching power supply may be used). The oven 100 may also include an electronics board to control the operation of the other components of the oven 100. During operation of the oven 100, these electrical components of the oven 100 (e.g., the magnetron, transformer, capacitor, and electronics board) produce waste heat. To remove this heat, the oven 100 may include a fan (not shown) driving an air flow into a top air duct to draw this heat away from the electrical components

Additionally, because the oven 100 may operate by heating water molecules, the cooking process tends to generate steam. This steam may condense on the cooler inside surfaces of the oven cavity 102. This condensation may be more prevalent when cooking foods of high moisture content for extended periods of time.

The oven 100 may include a light source 120 configured to provide illumination to the oven cavity. The light source may be arranged, at least partially, within the channel 110 so as to protect the light source from the heat and moisture generated within the oven cavity 102. The channel 110 may allow for the light source to reach the cavity 102. However, at least a portion of the light source, specifically the portion that may be harmed by radiation or high heat, may be arranged outside of the frame 104 in order to be protected from the microwaves. This is disclosed in more detail below.

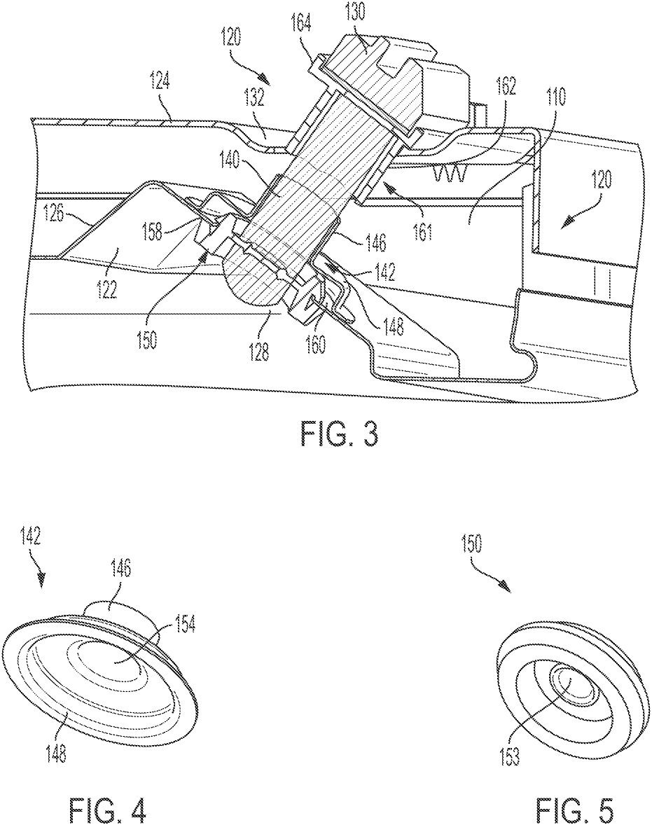

FIG. 2 illustrates a perspective view of the light source 120 for the microwave oven of FIG. 1. Referring also to FIG. 3 which illustrates a cutaway view of the light source of FIG. 2 along with the frame 104. The frame 104 may be formed of a metal and have bends and shapes. In one example, the frame 104 may have an exterior portion 124 and an interior portion 126 made from the same piece of metal. The exterior portion 124 and the interior portion 126 may be made of separate pieces of material. In one example, the interior portion 126 may also be the cavity wrapper 106 as discussed with respect to FIG. 1.

In this example, the interior portion 126 of the frame 104 may form a protruded portion 122 extending into the cavity 102 of the oven 100. The protruded portion 122 may define an inlet 128 providing an opening between the light source 120 and the oven cavity 102. The protruded portion 122 may be arranged at an angle relative to the frame 104 such that the inlet opens at an angular offset at the top of the cavity 102.

The light source 120 may be any illumination device capable of providing light or illuminations to the cavity. The light source 120 may include a printed circuit board (PCB) 130 configured to provide power and control a light emitting device arranged thereon. For example, the PCB 130 may include one or more light emitting diodes (LEDs) configured to provide light. The LEDs may be arranged directly on the PCB 130.

The external portion 124 of the frame 104 may define a recess 132 configured to receive the PCB 130. This is best illustrated in FIG. 3. The PCB 130 may reside, at least partially, within the recess 132.

The light source 120 may include a light guide 140 configured to guide the light from the PCB 130 into the oven cavity 102. The light guide 140 may have a cylindrical shape and may have reflective properties. In one example, the light guide may be made of metal. Other materials, especially those with reflective properties, may also be used. The light guide 140 may also be made of plastic, or other transparent or semi-transparent materials. The light guide 140 may extend from the PCB 130 to the inlet 128.

A cylinder 142 may be arranged at the inlet 128 and configured to receive the light guide 140. Referring to FIG. 4, the cylinder 142 may have a first portion 146 having a first diameter and extending into a second portion 148 having a second diameter, the second diameter being larger than the first diameter. The second portion 148 may be configured to be seated at the inlet 128 and configured to block any leakage of microwave waves.

As best illustrated in FIG. 3, the first portion 146 of the cylinder 142 receives the light guide 140. The cylinder 142 may define a cylinder opening 154 configured to allow light from the PCB 130 to pass through to the cavity 102.

As also illustrated in FIG. 3, the light source 120 may include a gasket 150 arranged at the inlet 128 within the second portion 148 of the cylinder 142. The gasket 150 may be made of a flexible material, such as silicone.

As best illustrated in FIG. 5, the gasket 150 may form a disc-like shape and define an opening 153 configured to align with the cylinder opening 154. In the example shown, the gasket 150 may form a donut-like or tire-like formation. Returning to FIG. 3, the gasket 150 may define a recessed lip 158 around the permitter of the gasket. The lip 158 may be configured to receive a projection 160 formed by the frame 104 around the inlet 128. The engagement between the lip 158 and the projection 160 may aid to secure the gasket 150 around the inlet 128.

The gasket 150 may be configured to receive a distal end of the light guide 140. That is, the light guide 140 may extend through the first portion 146 of the cylinder 142 and be received by the middle of the gasket 150. The gasket 150 may act as a stop for the light quite 140 and allow for a secure yet gentle fit with the light guide 140.

The second portion 148 of the cylinder 142 may receive the gasket and aid in retaining the gasket at the inlet 128. The cylinder 142 may also block any microwaves that may leak around the gasket 150 and prevent the microwaves from reaching the PCB 130.

Referring to FIG. 3 once more, a bracket 161 may be arranged at the proximal end of the light guide 140. The bracket 161 may have a cylindrical portion 152 configured to receive at least a portion of the light guide 140. The bracket 161 may include a seated lip 164 extending around the cylindrical portion 152 at one end. The seated lip 164 may be configured to receive and retain the PCB 130.

Thus, disclosed herein is a light source for a microwave oven. The light source may further include a cylindrical light guide configured to guide the light from a PCB to an inlet to provide the light generated from the LEDs into the cavity. To protect the PCB and prevent leaking microwaves from leaving the oven cavity and possibly damaging the PCB or other components, the light source may be arranged behind the oven frame and include a cylinder for receiving a light guide to guide the light to the cavity. The cylinder may form a cap or seal over the inlet in order to reflect the waves back into the cavity. The cylinder may be made of metal or other blocking materials. The cylinder may have two portions, the first portion being cylindrical and being configured to receive the light guide. The second portion may also be cylindrical and extend from the first portion, but have a larger diameter than the first portion. This may be in part in order to receive a silicone gasket. The second portion may encapsulate the gasket around the inlet so that the gasket can receive the end of the light guide and seal off the cavity. Accordingly, a low cost, low-modification light source may be presented to minimize or prevent microwave leakage and prolong the life of the light source. s

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. An oven having an illumination device for illuminating an oven cavity, the illumination device, comprising:
a light source having a printed circuit board (PCB) arranged exterior to the oven cavity;
a light guide extending from the PCB to direct light into the oven cavity via an inlet defined in the frame; and
a metal cylinder surrounding the light guide at the inlet to protect the PCB from microwave leakage.

2. The illumination device of claim 1, wherein the cylinder includes a first portion having a first diameter and extending into a second portion having a second diameter, the second diameter being larger than the first diameter.

3. The illumination device of claim 2, further comprising a gasket arranged within the first diameter of the cylinder.

4. The illumination device of claim 3, wherein the gasket is made of a flexible material.

5. The illumination device of claim 3, wherein the gasket is made of silicone.

6. The illumination device of claim 3, wherein the gasket forms a disc that defines a recessed lip around a permitter of the disc configured to receive a projection formed by the frame at the inlet.

7. The illumination device of claim 1, wherein the light source is at least one light emitting diode (LED).

8. A light device for illuminating an oven cavity, the light device, comprising:
a light emitting diode (LED) in communication with a printed circuit board (PCB) arranged exterior to a frame defining the oven cavity;
a light guide extending from the LED to direct light into the oven cavity via an inlet defined in the frame; and
a cylinder surrounding the light guide at the inlet to protect the PCB against microwave leakage.

9. The light device of claim 8, wherein the cylinder is made of a metal material.

10. The light device of claim 8, wherein the cylinder includes a first portion having a first diameter and extending into a second portion having a second diameter, the second diameter being larger than the first diameter.

11. The light device of claim 10, further comprising a gasket arranged within the first diameter of the cylinder.

12. The light device of claim 11, wherein the gasket is made of a flexible material.

13. The light device of claim 11, wherein the gasket is made of silicone.

14. The light device of claim 11, wherein the gasket forms a disc that defines a recessed lip around a permitter of the disc configured to receive a projection formed by the frame at the inlet.

15. A blocking cylinder for covering an inlet for a light device illuminating an oven cavity configured to block exposure to leaking microwaves, the blocking cylinder, comprising:
a first portion configured to receive a distal end of a light guide, the first portion having a cylindrical shape and a first diameter; and
a second portion extending from the first portion and configured to receive a gasket for further receiving the light guide, the second portion having a cylindrical shape and a second diameter.

16. The light device of claim 15, wherein the cylinder is made of a metal material.

17. The light device of claim 15, wherein the second diameter is larger than the first diameter.
